(19) United States
(12) Patent Application Publication
(10) Pub. No.: US 2017/0106505 A1
(43) Pub. Date: Apr. 20, 2017

(54) RATCHET WRENCH

(71) Applicant: Man-Chi Chang, Taichung (TW)

(72) Inventor: Man-Chi Chang, Taichung (TW)

(21) Appl. No.: 14/886,061

(22) Filed: Oct. 18, 2015

(51) Int. Cl. B25B 13/46; B25B 23/00

(52) U.S. Cl. CPC B25B 13/463; B25B 23/0035

(57) ABSTRACT

A ratchet wrench includes a tubular body, a ratchet unit, a driving head, a control unit and a connection unit. The ratchet unit is operated in either rotation mode or spinning mode. The control unit controls the ratchet unit to rotate clockwise or counter clockwise. The connection unit is connected with a tool. When the body is rotated, the ratchet unit drives the driving head to rotate an object connected to the driving head. When the tool is span relative to the body, the ratchet unit also drives the driving head to rotate an object.

### BACKGROUND OF THE INVENTION

1. Fields of the invention

The present invention relates to a ratchet wrench, and more particularly, to a ratchet wrench for efficiently driving an object.

2. Descriptions of Related Art

The conventional ratchet wrench is disclosed in U.S. Pat. No. 6,311,584, and comprises a handle having an internal gear formed in a head. One or more ring gears are rotatably received in the head and engaged with a bevel gear which is received in the handle for rotating the ring gears. A seat is rotatably received in the head and has a driving stem and includes two rotatable pawls each having two end teeth for selectively engaging with the internal gear and for selectively driving the driving stem. One or more rods are engaged between the ring gears and the seat to drive the seat and the driving stem with the ring gears.

However, the handle and the rods have no proper restriction mechanism to secure the connection therebetween so that there is a relative rotation between the handle and the rod. When a user holds the handle to rotate the rod, the handle spin slightly and this may cause unexpected result. The ratchet wrench cannot be cooperated with the normal screwdriver with a fixed handle, such that the range of use is restricted.

The present invention intends to provide a ratchet wrench to eliminate the shortcomings mentioned above.

### SUMMARY OF THE INVENTION

The present invention relates to a ratchet wrench and comprises a tubular body, a ratchet unit, a driving head, a control unit and a connection unit. The ratchet unit is operated in either rotation mode or spinning mode. The control unit controls the ratchet unit to rotate clockwise or counter clockwise. The connection unit is connected with a tool. When the body is rotated, the ratchet unit drives the driving head to rotate an object connected to the driving head. When the tool is span relative to the body, the ratchet unit also drives the driving head to rotate an object.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is an exploded view of the ratchet unit of the ratchet wrench of the present invention;

FIG. 3 is a perspective view to show the ratchet unit of the ratchet wrench of the present invention;

FIG. 4 is an exploded view of the connection unit of the ratchet wrench of the present invention;

FIG. 5 shows the inner arrangement of the sleeve of the connection unit of the ratchet wrench of the present invention;

FIG. 6 shows the tool to be connected with the ratchet wrench of the present invention;

FIG. 7 shows the parts in the tool in FIG. 6;

FIG. 8 is a top view of the tool in FIG. 7;

FIG. 9 is a side view of the tool in FIG. 7;

FIG. 10 is a perspective view to show that the tool is connected with the ratchet wrench of the present invention;

FIG. 11 is a side view of the combination in FIG. 10;

FIG. 12 is a cross sectional view, taken along line A-A in FIG. 12;

FIG. 13 is an enlarged view of the circled portion “B” in FIG. 12;

FIG. 14 is an enlarged view of the circled portion “C” in FIG. 12;

FIG. 15 is a cross sectional view to show that the tool is separated from the ratchet wrench of the present invention;

FIG. 16 is an enlarged view of the circled portion “C” in FIG. 15;

FIG. 17 is a perspective view to show that the tool is separated from the ratchet wrench of the present invention;

FIG. 18 shows that the tool is spanned by operating the ratchet wrench of the present invention;

FIG. 19 is a cross sectional view, taken along line F-F in FIG. 19, and

FIG. 20 is an enlarged view of the circled portion “G” in FIG. 19.

### DETAILED DESCRIPTION OF THE PREFERRED EMBODIMENT

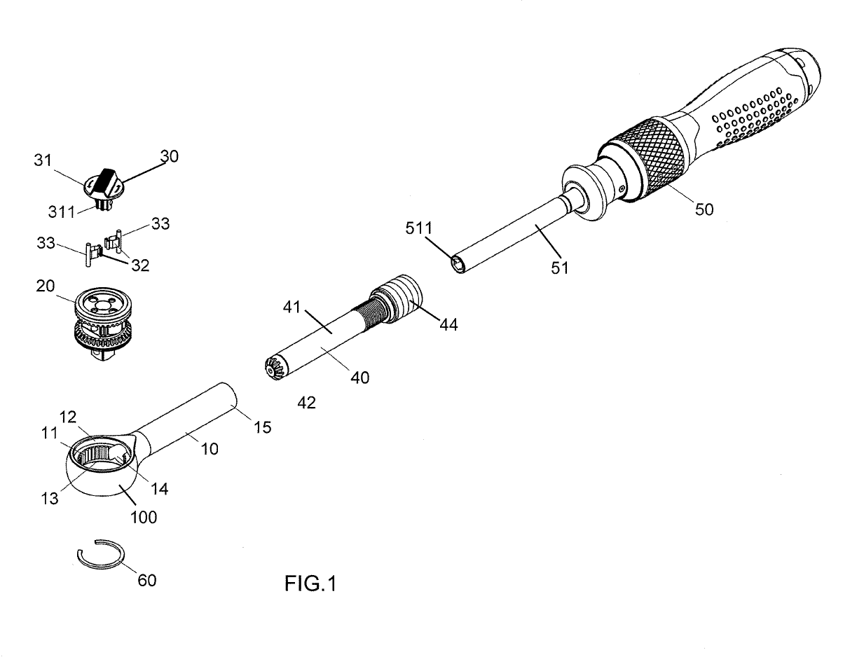

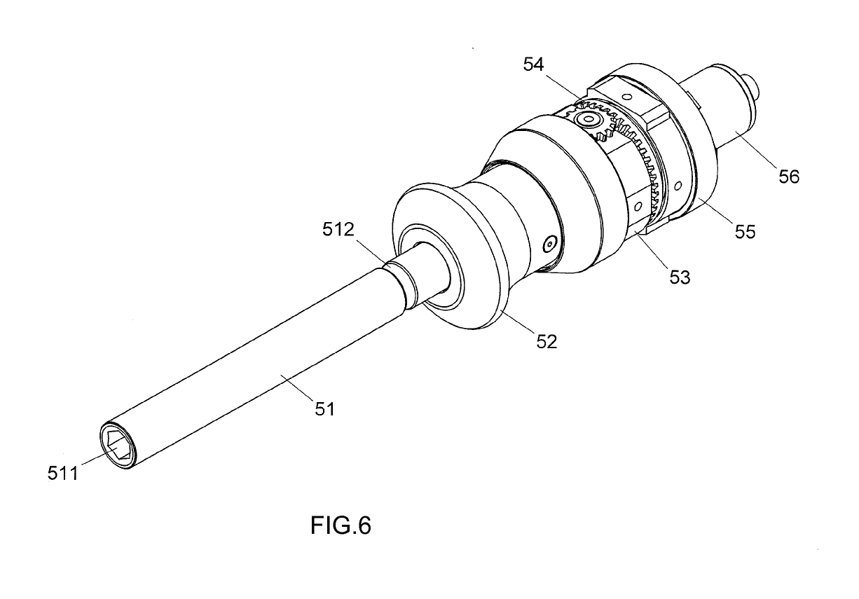

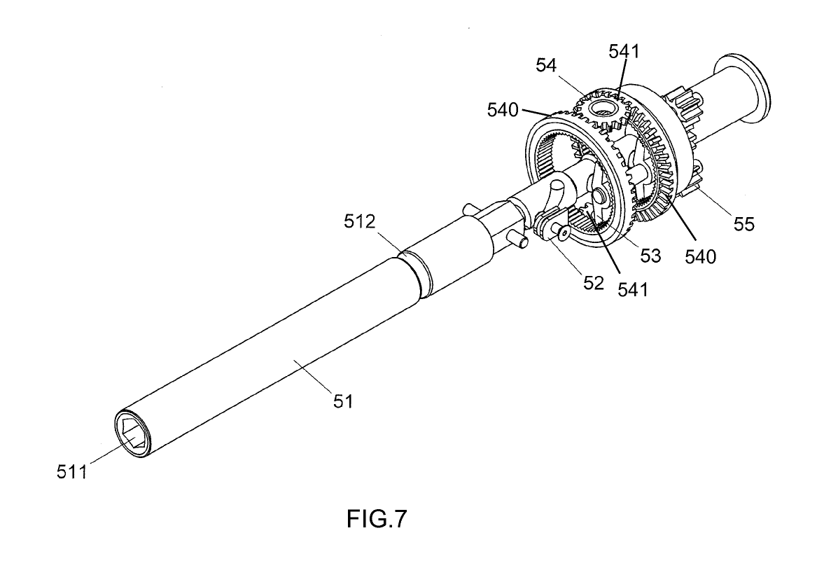

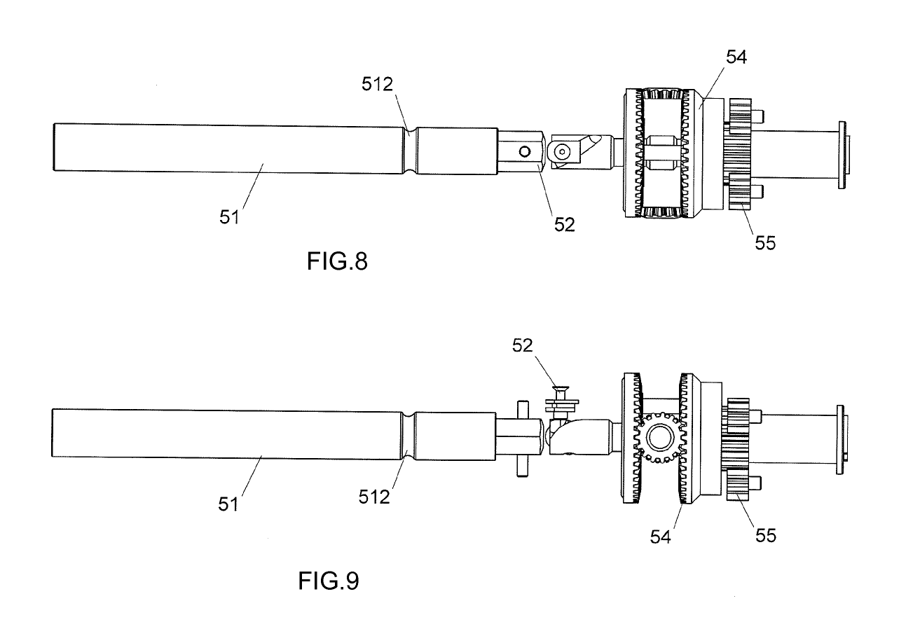

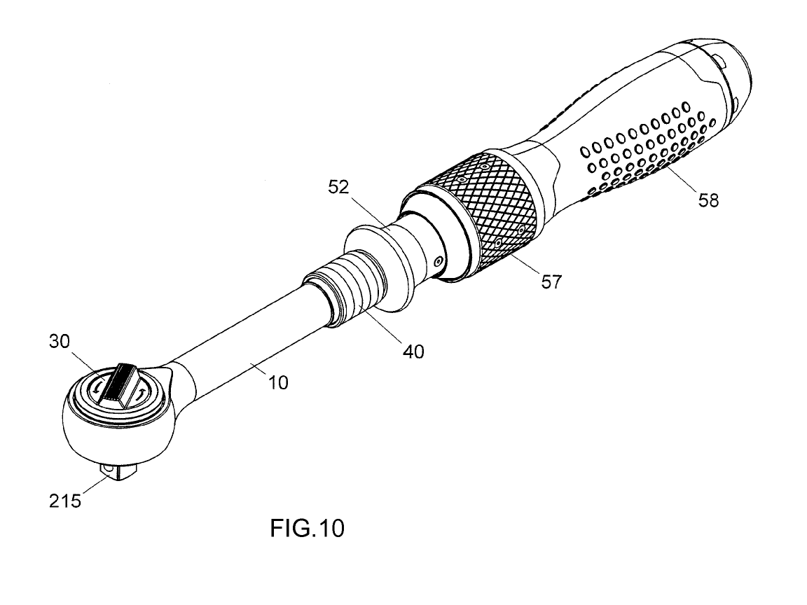

Referring to FIGS. 1 to 10, the ratchet tool of the present invention comprises a tubular body 10, a ratchet unit 20, a driving head 21, a control unit 30 and a connection unit 40. The body 10 has a function end 100 at the first end thereof, the function end 100 is a ring-like end and has a toothed portion 11 defined in an inner periphery thereof. A top circular slot 12 and a bottom circular slot 13 are respectively defined in the function end 100, and the toothed portion 11 is located between the top and bottom circular slots 12, 13. A passage 14 is defined axially in the body 10. A first connection portion 15 is formed at the second end of the body 10 and has inner teeth.

The ratchet unit 20 is located in the function end 100 and includes the driving head 21. The control unit 30 is connected to the function end 100 to control the ratchet unit 20 to rotate clockwise or counter clockwise. When the body 10 is rotated, the driving head 21 is rotated to rotate an object connected to the driving head 21. The driving head 21 has an operation portion 215 which is able to be connected with a rectangular recess of a socket, a rod or an adaptor.

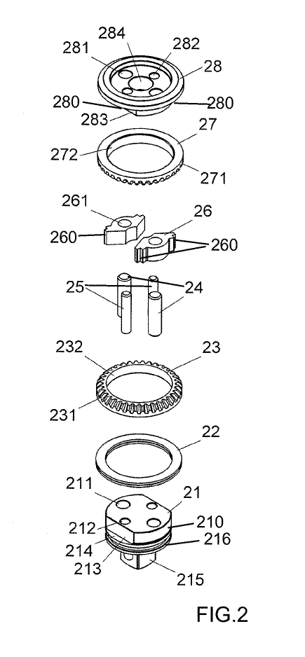

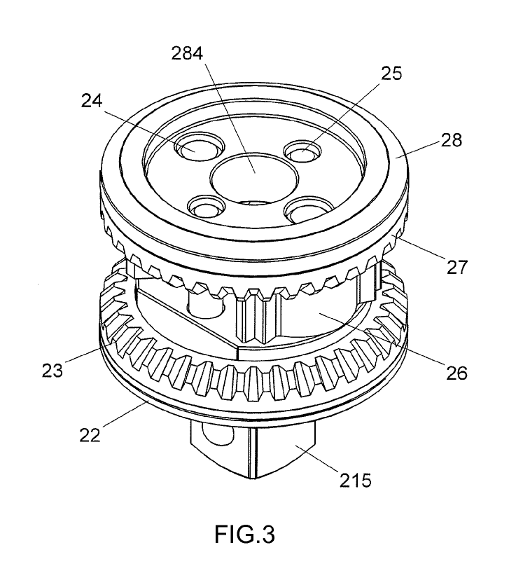

As shown in FIGS. 2 and 3, the ratchet unit 20 includes the driving head 21, a ring 22, a bottom toothed ring 23, two first pins 24, two second pins 25, two pawls 26, a top toothed ring 27 and a seat 28. The driving head 21 has two first circular holes 211 and two second circular holes 212 on the top thereof, wherein the first circular holes 211 are larger than the two second circular holes 212. The top section of the driving head 21 includes a cylindrical portion 210 which has two recessed areas 214 defined in two sides thereof. Each recessed area 214 has a flat first contact face 213. The driving head 21 has a rectangular driving portion 215 extending from the lower section thereof so as to be connected with a rectangular recess of a socket, a rod or an adaptor. The ring 22 is mounted to the cylindrical portion 210, wherein the diameter of the hole of the ring 22 is the same as the outer diameter of the cylindrical portion 210. The outer diameter of the ring 22 is larger than the diameter of the flange 216 on the middle portion of the driving head 21. The bottom toothed ring 23 has first teeth 231, the bottom toothed ring 23 is rotatably mounted to the cylindrical portion 210 and rested on the ring 22. A portion of the first inner periphery 232 of the bottom toothed ring 23 faces the first contact face 213 to form the recessed area 214. The first pins 24 are inserted into the first circular holes 211, and the second pins 25 are inserted into the second circular holes 212. The two pawls 26 are connected to the top of the driving head 21. Each pawl 26 has engaging teeth 260 formed in each of the two ends thereof so as to be engaged with the toothed portion 11. The pawls 26 each have a first pivot hole 261 which is in alignment with the first circular hole 211 so that the first pin 24 extends through the first pivot hole 261 and the first circular hole 211 corresponding thereto. The top toothed ring 27 has the same diameter as the bottom toothed ring 23. The top toothed ring 27 has second teeth 271 which are located corresponding to the first teeth 231. The top toothed ring 27 has a second inner periphery 272. The seat 28 is located above the driving head 21. The top toothed ring 27 is mounted to the lower section of the seat 28. The seat 28 has two third circular holes 281 and two fourth circular holes 282 which are respectively located corresponding to the first circular holes 211 and the second circular holes 212. The first pins 24 extend through the third circular holes 281, and the second pins 25 extend through the fourth circular holes 282. The seat 28 has two recessed areas 280 defied in two sides of the lower end thereof, each recessed area 280 of the seat 28 has a flat second contact face 283 which is located on the same plane as the first contact face 213 corresponding thereto. The seat 28 has a central hole 284 defined therethrough. The second clip 60 is mounted to the outside of the driving head 21 to restrict the ratchet unit 20 from dropping from the function end 100.

As shown in FIGS. 1 and 11-13, the control unit 30 has a controller 31, two first resilient members 32 and two pivots 33. The controller 31 has a protrusion 311 which has two notch 3110 on two sides thereof. The protrusion 311 extends through the central hole 284. The top of the controller 31 is exposed from the seat 28 so that the user can operate the controller 31 by rotating the top of the protrusion 311. The first pins 24 extend through the first pivot holes 261, and two ends of each first pin 24 are engaged with the first circular hole 211 and the third circular hole 281. The second pins 25 respectively extend through the first resilient members 32. The two ends of each of the resilient members 32 contact the protrusion 311 and the pivot 33 corresponding thereto. The two ends of each second pin 25 are respectively engaged with the second circular hole 212 and the fourth circular hole 282 corresponding thereto. Each first resilient member 32 has a convex curved portion which is pivotably engaged with the notch 3110 of the protrusion 311 corresponding thereto. Each first resilient member 32 has a concaved curved portion which is pivotably engaged with the pivot 33 corresponding thereto. Each of the two pivots 33 contacts the recessed area 214 of the driving head 21 corresponding thereto. One of the two ends of each pivot 33 is located between the first contact face 213 and the first inner periphery 232, and the other end of the pivot 33 is located between the second contact face 283 and the second inner periphery 272. When rotating the controller 31 to pivot the pawl 26 to rotate about the first pin 24,, the controller 31 drives the first resilient member 32 which moves the pivot 33 in the recessed area 214 so as to control the direction of rotation of the ratchet unit 20. The engaging teeth 260 of the pawl 26 are engaged with the toothed portion 11.

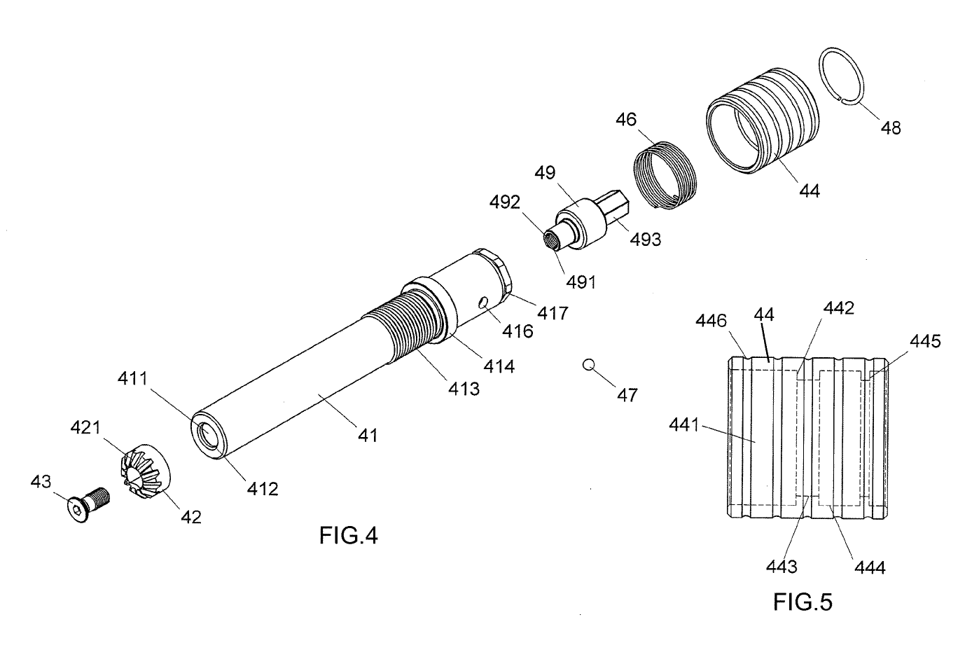

As shown in FIGS. 4 and 5, the connection unit 40 has a tube 41, the driving member 42, a fixing member 43, a sleeve 44, a spring 46, a bead 47 and a sealing member 48. The tube 41 extends through the passage 14 defined axially in the body 10 and has a room 411 defined axially therein. The room 411 of the tube 40 has a restriction portion 412 formed at the first end of the tube 40. A second connection portion 413 with threads is formed at the outside of the middle portion of the tube 41 and is connected to the second connection portion 15 of the body 10. A flange 414 extends outward and radially from the outside of the tube 41. A hole 416 is defined radially in the wall of the tube 41 and communicates with the room 411. The driving member 42 is fixedly connected to a driving block 49 which is rotatably received in the room 411. The restriction portion 412 restricts the driving block 49 from dropping from the tube 40. The driving block 49 has a first engaging portion 493 extending from one end thereof so as to be connected with a second engaging portion 511 of a rod 51 of a tool 50 which has a handle 58. The first engaging portion 493 is a hexagonal rod and the second engaging portion 511 is a hexagonal recess. The driving block 49 has a non-circular extension 491 extending from the other end thereof. The extension 491 has a receiving hole 492 in which threads are defined. The extension 491 is co-rotatably inserted in the driving member 42 by using the fixing member 43. The driving member 42 is exposed from the first end of the tube 40. The third teeth 421 are engaged with the first and second teeth 231, 271 simultaneously so as to rotate the ratchet unit 20 within the function end 100.

The sleeve 44 is mounted to the tube 40 and axially movable along the tube 40 between a releasing position and an engaging position. The sleeve 44 has an anti-slip surface 446 which includes multiple ridges. The sleeve 44 has a reception area 441 defined in the first end thereof. A front stop 443 and a rear stop 445 respectively extend inward from the inner periphery of the sleeve 44. The front stop 443 has a step face 442 facing the first end of the sleeve 44 which is located corresponding to the flange 414 of the tube 41. The spring 46 is mounted to the tube 40 and received in the reception area 441. The spring 46 is biased between the stop face 442 and the flange 44 to provide a force to move the sleeve 44 between the releasing portion and the engaging position. The bead 47 partially protrudes from the hole 416 of the tube 41. The sealing member 48 contacts against the rear stop 445 and located outside of the tube 40 to restrict the sleeve 44 and the spring 46 from dropping from the tube 40. The tube 40 has a groove 417 defined in the outside thereof. The sealing member 48 is a C-shaped clip which has a portion engaged with the groove 417, another portion of the sealing member 48 protrudes from the groove 417 and contacts the rear stop 445.

As shown in FIGS. 6 to 9, the rod 51 of the tool 50 is connected to the driving block 49 so as to drive the driving member 42. The tool 50 includes the cylindrical rod 51, a switch unit 52, a ratchet unit 53, a differential unit 54, a planet gear set 55, a connector 56, an outer sleeve 57 and a handle 58. The rod 51 rotatably extends through the room 411 of the tube 41, and has a hexagonal second engaging portion 511 which is connected to the first engaging portion 493. When spinning the rod 51, the driving block 49 and the driving member 42 are rotated about the passage 14. The rod 51 has a groove 512 which is located corresponding to the hole 416 for receiving the bead 47, such that the bead 47 is engaged with the groove 512. The rod 51 is restricted by the bead 47, and the second engaging portion 511 is restricted by the first engaging portion 493. The ratchet unit 53 provides the tool 50 with the ratcheting function. The switch unit 52 allows the user to change the direction of rotation of the ratchet unit 53. The differential unit 54 makes the rod 51 to rotate clockwise regardless of the rotation of the ratchet unit 53. When operating the switch unit 52, the differential unit 54 makes the rod 51 to rotate counter clockwise regardless of the rotation of the ratchet unit 53. The differential unit 54 includes four bevel gears 540/541, wherein the two bevel gears 540 are perpendicularly engaged with the other two bevel gears 541. The planet gear set 55 allows the rod 51 to be rotated at high speed. The connector 56 is fixed to the tool 50 and is connected to the planet gear set 55.

As shown in FIGS. 6-10, the outer sleeve 57 is mounted to outside of the ratchet unit 54 and the planet gear set 54 to stably receive the ratchet unit 54 and the planet gear set 54 in the tool 50. The handle 58 is connected to the tool 50 and the connector 56 so that a user can hold the handle 58 to rotate the rod 51. If the tool 50 is a screwdriver, then the switch unit 52, the ratchet unit 53, the differential unit 54, the planet gear set 55, the connector 56 and the outer sleeve 57 can be omitted. The handle 58 is directly connected to the rod 51. If the tool 50 is a ratchet screwdriver, the differential unit 54 and the planet gear set 55 will be not necessary, and the connector 56 is directly connected to the ratchet unit 53.

As shown in FIGS. 12, 14, the sleeve 44 is mounted to the tube 41, and the spring 46 provides a force to move the sleeve 44 between the releasing position and the engaging position. When the sleeve 44 is located at the engaging position, the bead 47 is pushed inward by the front stop 443 and engaged with the groove 512. The rod 51 is fixed to the tube 41. The tool 50 is connected to the connection unit 40.

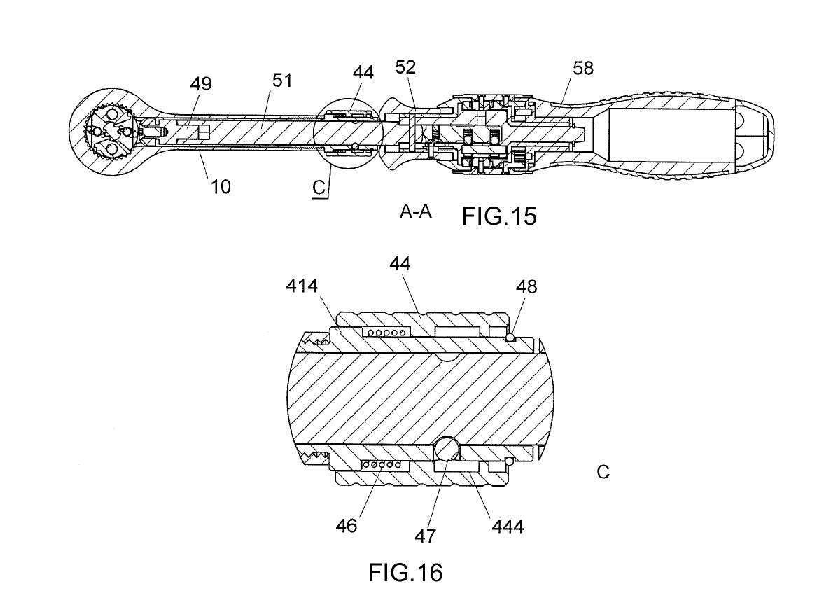

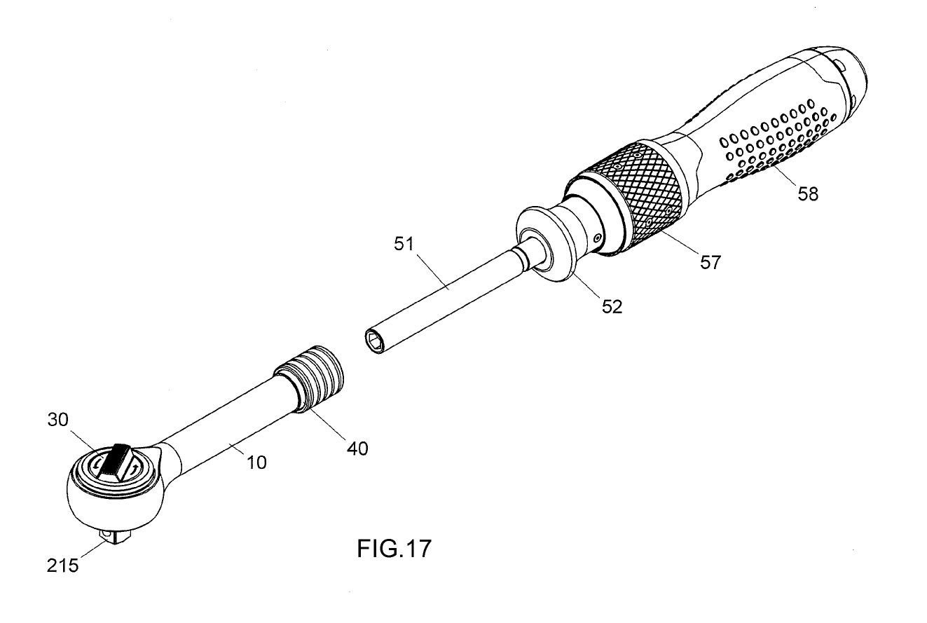

As shown in FIGS. 15, 16, when the sleeve 44 is pushed toward the ratchet unit 20 to the releasing position, the spring 46 is compressed so that the annular groove 444 faces the hole 416, and the front stop 443 no longer pushes the bead 47 which is released from the groove 512. The rod 51 is not fixed to the tube 41, so that the rod 51 can be pulled out from the tube 41 as shown in FIG. 17. The second engaging portion 511 of rod 51 can be used to be connected with other tool or part.

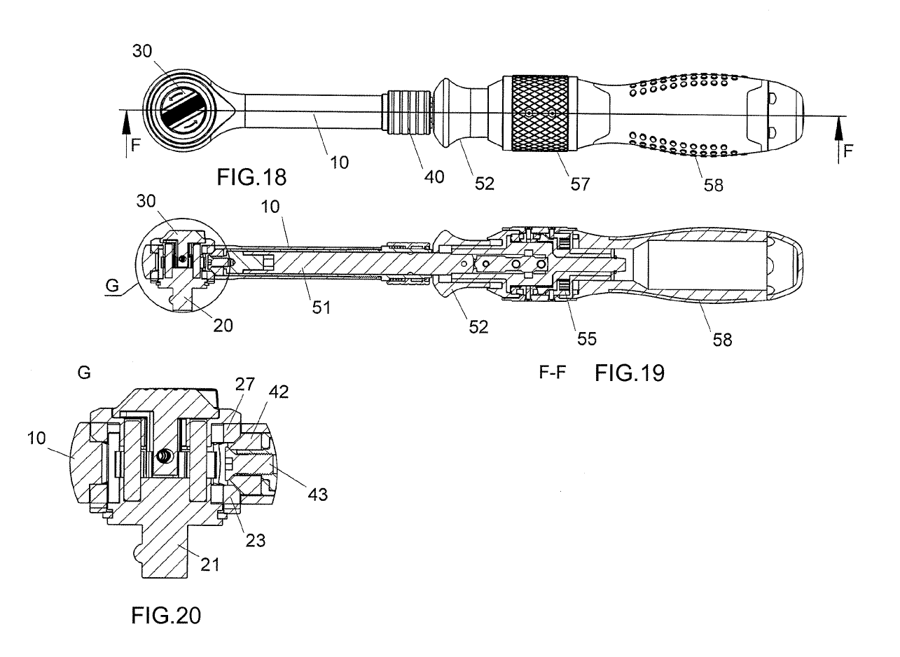

As shown in FIGS. 18-20, when the user rotates the handle 58 360 degrees, the rod 51, the driving block 49 and the driving member 42 are rotated, the driving member 42 then drives the bottom toothed ring 23, the top toothed ring 27 and the ratchet unit 20 360 degrees, so that the operation portion 215 can drive another tool.

FIGS. 4 and 6 show that first engaging portion 493 and the second engaging portion 511 can be hexagonal engagement.

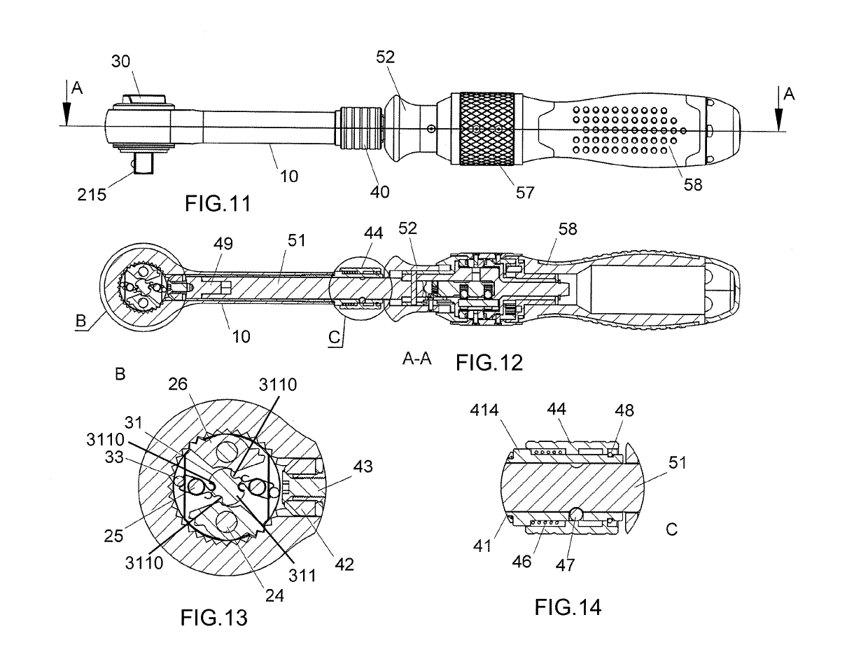

The advantages of the present invention are that the tool 50 is connected to the connection unit 40 to be a wrench when the sleeve 44 is located at the engaging position as shown in FIGS. 11 and 14. As shown in FIG. 16, when sleeve 44 is located at the releasing position, the rod 51 can be separated from the tube 41 and the tool 50 can be used individually as shown in FIG. 17. The connection unit 40 can be directly connected with existed tools. The connection unit 40 is easily assembled to or separated from the body 10 to conveniently replace the driving member 42. As shown in FIG. 17, when the body 10 is not long enough, a long connection rod can be easily connected to the body 10.

While we have shown and described the embodiment in accordance with the present invention, it should be clear to those skilled in the art that further embodiments may be made without departing from the scope of the present invention.

What is claimed is:

1. A ratchet wrench comprising:
a body having a function end at a first end thereof, a first connection portion formed at a second end of the body;
a ratchet unit connected to the function end and having a driving head;
a control unit connected to the function end to control the ratchet unit to rotate clockwise or counter clockwise, when the body is rotated, the driving head is rotated for rotating an object, and
a connection unit rotatably received in the body to drive a driving block, a driving member connected to the driving block and co-rotated with the driving member, the driving member driving the driving head, the connection unit having a tube, a sleeve, a spring, a bead and a sealing member, the tube extending through a passage defined axially in the body and having a room defined axially therein, a second connection portion formed at an outside of a middle portion of the tube and connected to the second connection portion of the body, a flange extending outward and radially from the outside of the tube, a hole defined radially in a wall of the tube and communicating with the room, the driving member fixedly connected to the driving block which is rotatably received in the room, the driving member exposed from a first end of the tube, the sleeve mounted to the tube and axially movable along the tube between a releasing position and an engaging position, the sleeve having a reception area defined in a first end thereof, a front stop and a rear stop respectively extending inward from an inner periphery of the sleeve, the front stop having a step face facing the first end of the sleeve which is located corresponding to the flange of the tube, the spring mounted to the tube and received in the reception area, the spring being biased between the stop face and the flange to provide a force to move the sleeve between the releasing portion and the engaging position, the bead partially protruding from the hole of the tube, the sealing member contacting against the rear stop and located outside of the tube to restrict the sleeve and the spring from dropping from the tube, the driving block having a first engaging portion extending from one end thereof so as to be connected with a second engaging portion of a rod of a tool which has a handle.

2. The ratchet wrench as claimed in claim 1, wherein the driving block has a non-circular extension extending from the other end thereof, the extension has a receiving hole in which threads are defined, the extension is co-rotatably inserted in the driving member, the tube has a groove defined in an outside thereof, the sealing member is a C-shaped clip which has a portion engaged with the groove, another portion of the sealing member protrudes from the groove and contacts the rear stop.

3. The ratchet wrench as claimed in claim 1, wherein the room of the tube has a restriction portion formed at the first end of the tube, the restriction portion restricts the driving block from dropping from the tube.

4. The ratchet wrench as claimed in claim 1, wherein the driving head has an operation portion which is adapted to be connected with a rectangular recess of a socket, a rod or an adaptor.

5. The ratchet wrench as claimed in claim 1, wherein the sleeve has an anti-slip surface which includes multiple ridges.

6. The ratchet wrench as claimed in claim 1, wherein the first engaging portion is a hexagonal rod and the second engaging portion is a hexagonal recess.

7. The ratchet wrench as claimed in claim 1, wherein the tool with the handle is a screwdriver.
